(19) United States
(12) Patent Application Publication
(10) Pub. No.: US 2025/0214163 A1
(43) Pub. Date: Jul. 3, 2025

(54) Cutting Tool with Inserted Teeth

(71) Applicant: The M. K. Morse Company, Canton, OH (US)

(72) Inventors: Chandra Rakurty, Massillon, OH (US); Joseph Tarr, East Canton, OH (US)

(21) Appl. No.: 18/876,990

(22) PCT Filed: Jun. 23, 2023
(86) PCT No.: PCT/US2023/026167

§ 371 Date: Dec. 19, 2024

Related U.S. Application Data
(60) Provisional application No. 63/354,939, filed on Jun. 23, 2022.

(51) Int. Cl. B23D 61/16; B27B 33/12

(52) U.S. Cl. CPC B23D 61/16; B27B 33/12

(57) ABSTRACT

A cutting tool includes a main body having a pocket with a multi-faced bottom surface and a multi-faced back surface. A tooth is disposed in the pocket and has a corresponding multi-faced bottom surface and a multi-faced back surface.

### CROSS-REFERENCE TO RELATED APPLICATIONS

This application is a National Phase filing of International Application Ser. No. PCT/US2023/026167, for a CUTTING TOOL WITH INSERTED TEETH, filed Jun. 23, 2023, which claims priority to and the benefit of U.S. Provisional Patent Application No. 63/354,939, filed 23 Jun. 2022, the contents of which is hereby incorporated by reference in its entirety.

### BACKGROUND

This relates in general to cutting tools. One category of cutting tools is generally planar cutting tools, such as circular saws, band saws, reciprocating saws, and the like. Such tools generally include a generally planar main body with cutting teeth along at least one edge.

### SUMMARY

This relates more particularly to a cutting tool with inserted cutting teeth.

In at least one embodiment a cutting tool includes a main body having a pocket (or tooth seat or insert seat) with a multi-faced bottom surface and a multi-faced back surface. A tooth (or tooth insert or insert assembly) is disposed in the pocket and has a corresponding multi-faced bottom surface (or longitudinal mating surface) and a multi-faced back surface (or vertical mating surface).

In at least one embodiment the respective multi-faced bottom surface and multi-faced back surface of the pocket and of the tooth cooperate, respectively, to center a tip of the tooth relative to a plane of the main body.

In at least one embodiment the respective multi-faced bottom surface and multi-faced back surface of the pocket and of the tooth have reciprocal geometry.

In at least one embodiment the tooth is press fit into the pocket.

In at least one embodiment the tooth is retained in the pocket with an interference fit that urges the tooth toward the bottom surface of the pocket and the back surface of the pocket.

In at least one other embodiment a cutting tool includes a main body having plurality of insert seats (or tooth seat or pocket). Each seat has a longitudinal mating surface (or multi-faced bottom surface) and vertical mating surface (or multi-faced back surface) with a recess formed therebetween. The tool also includes a plurality of insert assemblies (or tooth inserts or teeth), each disposed in a respective insert seat. Each insert assembly has a bottom surface reciprocal to the longitudinal mating surface and has a back surface reciprocal to the vertical mating surface. A cutting portion of the insert assembly extends beyond the vertical mating surface and a retention portion of the insert assembly extends partially into the recess where the insert assembly is retained in compression relative to the main body while the pocket is at least partially in tension.

The longitudinal mating surface may include a longitudinally extending peak disposed centrally along the transverse of the main body.

The bottom surface may include a reciprocal longitudinally extending valley disposed centrally along the transverse of the insert assembly.

The vertical mating surface may include a vertically extending peak disposed centrally along the transverse of the main body.

The back surface may include a vertically extending valley disposed centrally along the transverse of the insert assembly.

In at least one further embodiment, a method for using a cutting tool includes the steps of: providing a main body having plurality of tooth seats (or insert seats or pockets), each of the plurality of tooth seats having a longitudinal mating surface (or multi-faced bottom surface) and vertical mating surface (or multi-faced back surface) with a recess formed therebetween; providing a plurality of tooth inserts (or teeth or insert assemblies), each of the plurality of tooth inserts having a bottom surface reciprocal to the longitudinal mating surface, and having a back surface reciprocal to the vertical mating surface; and respectively pressing each of the plurality of tooth inserts into one of the plurality of tooth seats such that a respective cutting portion of the tooth insert extends beyond the respective vertical mating surface and a respective retention portion of the tooth insert extends partially into the respective recess where the tooth insert is retained in compression relative to the main body while the pocket is at least partially in tension, and the tooth insert is laterally centered within the recess.

The retention portion of the tooth insert may extend only partially into the recess such that there is an open space between the retention portion and a portion of the pocket and the method can further include the step of placing a tool in the open space and using the tool to eject the tooth insert from tooth seat.

The method may further include the step of pressing a new tooth insert into the recess from which a previous tooth insert was ejected.

Further, the longitudinal mating surface may include a longitudinally extending peak disposed centrally along the transverse of the main body, the bottom surface of the respective tooth insert may include a reciprocal longitudinally extending valley disposed centrally along the transverse of the tooth insert, and prior to the pressing the longitudinal peak and longitudinal valley may be axially aligned.

Further the vertical mating surface may include a vertically extending peak disposed centrally along the transverse of the main body, the back surface may include a vertically extending valley disposed centrally along the transverse of the tooth insert, and prior to the pressing the vertically extending peak and vertically extending valley may be aligned parallel.

Various aspects will become apparent to those skilled in the art from the following detailed description and the accompanying drawings.

### BRIEF DESCRIPTION OF THE DRAWINGS

FIG. 1 is an isometric view of a portion of a main body having a pocket.

FIG. 2 is an isometric view of a tooth for insertion into the pocket shown in FIG. 1.

FIG. 3 is a partial side view of the main body and shows the tooth shown in FIG. 2 positioned in the pocket shown in FIG. 1.

### DETAILED DESCRIPTION

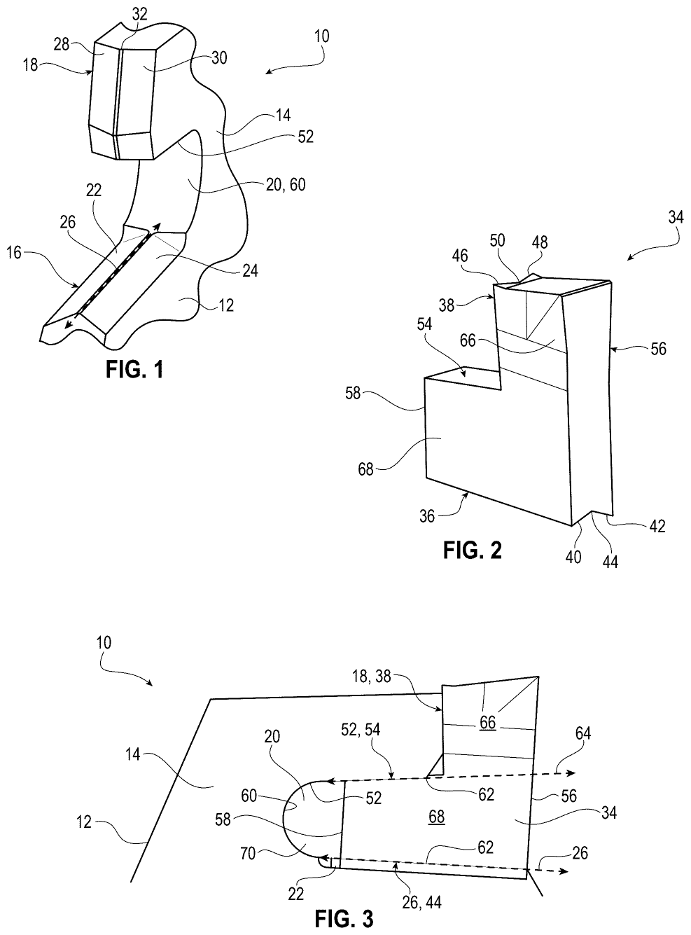

Referring now to the drawings, there is illustrated in FIGS. 1-3 an exemplary cutting tool 10 having a main body 12. As shown in FIG. 1, the main body includes a pocket-forming portion 14. The pocket-forming portion 14 has at least two surfaces that are multi-faced, one on the bottom of the pocket designated herein as a bottom surface 16 or longitudinal mating surface and on the back of the pocket a back surface 18 or vertical mating surface. A recess 20 is between the multi-faced bottom surface 16 and the multi-faced back surface 18. As shown best in FIG. 3, the recess 20 defines a bottom referenced at 60 and an opening referenced at 62. The exemplary multi-faced bottom surface 16 includes tooth contact surfaces/faces indicated in FIGS. 1 at 22 and 24. The multi-faced bottom surface includes a longitudinally extending edge or peak 26 between the faces 22, 24. The multi-faced back surface 18 includes faces 28, 30 and a vertically extending edge or peak 32 between the faces 28, 30. FIGS. 1 and 3 also shows that the pocket-forming portion 14 also defines a planar downwardly-facing surface 52 confronting the multi-faced bottom surface 16. FIG. 3 also shows an axis 64 that extends in the plane defined by surface 52 and shows the extension of the edge 26 as an axis. As shown in FIG. 2, a tooth 34 includes a multi-faced bottom surface 36 and a multi-faced back surface 38. The multi-faced bottom surface 36 includes faces 40 and 42 and a longitudinally extending edge or valley 44 between the faces 40, 42. The multi-faced back surface 38 includes faces 46 and 48 and a longitudinally extending edge or valley 50 between the faces 46, 48. FIG. 2 also shows that the tooth 34 also defines a surface 54 on an opposite side of the multi-faced bottom surface 36. FIG. 2 also shows that the tooth 34 also defines a front face surface 56 and a rear face surface 58. The faces 40 and 42 of the tooth 34 have reciprocal geometry to the faces 22 and 24 of the bottom surface 16 and the faces 46 and 48 of the tooth 34 have reciprocal geometry to the faces 28 and 30 of the back surface 18 to cooperate together to retain the position of the tooth 34 relative to the main body 12. In particular, it is believed that the illustrated geometry will keep a tip of the tooth centered relative to a position on the body.

The tooth 34 is shown partially disposed in the recess 20 of the pocket-forming portion 14 in FIG. 3. The tooth 34 includes a cutting portion 66 that extends beyond the multi-faced back surface 18 and a retention portion 68 that extends only partially into the recess 20 resulting in an open space (referenced at 70 in FIG. 3) between the retention portion 68 and surface 52. The planar downwardly facing surface 52 and the longitudinally extending edge 26 converge toward another in a direction from the opening 62 of the recess 20 towards the bottom 60 of the recess 20. As such, the tooth 34 may be press fit in the recess 20 of the pocket-forming portion 14. In the present example there is interference geometry fit between the tooth 34 and the pocket-forming portion 14 to hold the tooth 34 in a desired position. For example, downward force acting on surface 54 by the surface 52 may clamp the tooth 34 between surface 52 and the multi-faced bottom surface 16. The tooth 34 may be stopped relative to insertion in the main body 12 at a desired location, for example, when the multi-faced back sure 18 and the multi-faced back surface 38 come into contact with one another.

While principles and modes of operation have been explained and illustrated with regard to particular embodiments, it must be understood, however, that this may be practiced otherwise than as specifically explained and illustrated without departing from its spirit or scope.

1. A cutting tool comprising:
a main body having a pocket-forming portion with a multi-faced bottom surface with first and second faces and a longitudinally extending edge extending between said first and second faces, a multi-faced back surface with first and second faces and a vertically extending edge between said first and second faces of said multi-faced back surface, and a planar downwardly facing surface confronting said multi-faced bottom surface with a recess of said pocket-forming portion defined between said multi-faced bottom surface and said planar downwardly facing surface;
a tooth disposed in the pocket and having a multi-faced bottom surface that is engaged with and has reciprocal geometry to said multi-faced bottom surface of said pocket-forming portion and a multi-faced back surface that is engaged with and has reciprocal geometry to said multi-faced back surface of said pocket-forming portion; and
wherein said planar downwardly facing surface and said longitudinally extending edge converge toward another in a direction from an opening of said recess towards a bottom of said recess.

2. The cutting tool of claim 1 where said multi-faced bottom surface of said pocketing-forming portion, said multi-faced bottom surface of said tooth, said multi-faced back surface of said pocket-forming portion, and multi-faced back surface of said tooth cooperate to center a tip of said tooth relative on a plane extending through said main body.

3.-4. (canceled)

5. The cutting tool of claim 1 wherein said tooth is press fit in said recess of said pocket-forming portion.

6. The cutting tool of claim 1 wherein said tooth is retained in said recess of said pocket-forming portion with an interference fit that urges said tooth toward said multi-faced bottom surface of said pocket-forming portion and said multi-faced back surface of said pocket-forming portion.

7. The cutting tool of claim 1 wherein said tooth includes a cutting portion that extends beyond said multi-faced back surface of said pocket-forming portion and a retention portion that extends only partially into said recess resulting in an open space between said retention portion and said planar downwardly facing surface.

8.-14. (canceled)

15. A method of making a cutting tool comprising:
pressing part of a retention portion of a tooth into a recess defined between a longitudinally extending edge of a multi-faced bottom surface of a pocket-forming portion of a main body of a cutting tool and a planar downwardly facing surface of the pocket-forming portion that confronts the multi-faced bottom surface, while the tooth is maintained in a centered orientation relative to the recess by cooperative engagement between the multi-faced bottom surface and a multi-faced bottom surface of the tooth that shares reciprocal geometry with the multi-faced bottom surface of the pocket-forming portion, and wherein the planar downwardly facing surface and the longitudinally extending edge converge toward another in a direction from an opening of the recess towards a bottom of the recess.

16. The method of claim 15 wherein said pressing is further defined as:
pressing the part of the retention portion of the tooth into the recess defined between the longitudinally extending edge of a multi-faced bottom surface of the pocket-forming portion of the main body of the cutting tool and the planar downwardly facing surface of the pocket-forming portion that confronts the multi-faced bottom surface, while the tooth is maintained in the centered orientation relative to the recess by cooperative engagement between the multi-faced bottom surface and the multi-faced bottom surface of the tooth that shares reciprocal geometry with the multi-faced bottom surface of the pocket-forming portion, and wherein the planar downwardly facing surface and the longitudinally extending edge converge toward another in the direction from the opening of the recess towards the bottom of the recess and such that there is an open space between the retention portion and the bottom of the recess and method further comprises the step of:
placing a tool in the open space; and
ejecting the tooth from the recess with the tool.

17. The method of further comprising:
pressing, after said ejecting, a part of a retention portion of a second tooth into the recess.

18. The method of claim 15 further comprising:
axially aligning, prior to said pressing, the the multi-faced bottom surface of the pocketing-forming portion and the multi-faced bottom surface of the tooth.

19. (canceled)
